(19) United States
(12) Patent Application Publication
(10) Pub. No.: US 2012/0241380 A1
(43) Pub. Date: Sep. 27, 2012

(54) LIQUID-SOLID COUNTERCURRENT EXTRACTION SYSTEM HAVING REDUCED LIKELIHOOD OF ROTARY VALVE CAVITATION

(75) Inventors: Franz-Marcus Nowak, Arlington Heights, IL (US); Lewis Pettengill, Des Plaines, IL (US)

(73) Assignee: UOP LLC., Des Plaines, IL (US)

(21) Appl. No.: 13/071,860

(22) Filed: Mar. 25, 2011

(51) Int. Cl. B01D 37/04; B01D 15/08

(52) U.S. Cl. 210/660; 210/137

(57) ABSTRACT

Embodiments of a liquid-solid countercurrent extraction system are provided, as are embodiments of a method for reducing the likelihood of rotary valve cavitation during liquid-solid countercurrent extraction. In one embodiment, the extraction system includes an adsorbent chamber and a rotary valve fluidly coupled to the adsorbent chamber. The rotary valve directs a first net stream into a different section the adsorbent chamber in each of a plurality of indexed positions. A first flow control element is fluidly coupled between the rotary valve and the source of the first net stream, and a controller is operably coupled to the first flow control element. The controller is configured to modulate the first flow control element during indexing of the rotary valve to reduce the flow rate of the first net stream and thereby maintain sufficient pressure of the first net stream to prevent cavitation within the rotary valve.

### FIELD OF THE INVENTION

The present invention relates generally to extraction processes and, more particularly, to systems and methods for reducing the likelihood of rotary valve cavitation during liquid-solid countercurrent extraction performed under high throughput conditions.

### DESCRIPTION OF RELATED ART

Liquid-solid countercurrent extraction processes enable the extraction of one or more desired products from mixed component streams at purities often exceeding those attainable utilizing other types of extraction processes. During a typical liquid-solid countercurrent extraction process, a mixed component feed stream and a desorbent stream are injected into at least one adsorbent chamber, which contains a number of fixed adsorbent beds, while product and raffinate streams are withdrawn from the adsorbent chamber. Countercurrent flow of the solid adsorbent beds is simulated by continually varying the location at which the net streams are injected into and withdrawn from the adsorbent chamber during the extraction process. More specifically, the locations at which the feed and desorbent streams are injected into and the locations at which the extract and raffinate streams are withdrawn from the adsorbent chamber are periodically varied, in a stepwise manner, to achieve a moving concentration profile within the adsorbent chamber, which simulates countercurrent flow of the fixed adsorbent beds relative to the liquid feed without requiring actual movement of the adsorbent beds.

Continual movement of the points of injection and withdrawal of the net streams can be accomplished utilizing a relatively complex network of conduits and flow control valves. However, to eliminate the need for such a complex flow network, a specialized valve referred to as a “co-planar manifolding indexing valve” or, more simply, “a rotary valve” has been developed by the assignee of the present application, UOP LLC. Generally, a rotary valve includes a stationary track plate and a rotor plate, which is positioned adjacent (e.g., immediately above) the track plate and can rotate relative thereto amongst a series of indexed positions. The neighboring faces of the track plate and the rotor plate each have multiple ports therein (referred to herein as “indexing ports”), which move into and out of alignment as the rotor plate rotates between indexed positions. During the liquid-solid countercurrent extraction process, the rotor plate is sequentially moved from one indexed position to the next to change port alignment within the rotary valve and thereby vary the stream routing to and from the adsorbent chamber and the fixed adsorbent beds contained therein. A seal sheet fabricated from a low friction material (e.g., TEFLON®) is typically positioned between the rotor plate and the track plate to help isolate the different process streams flowing through the rotary valve.

As the rotor plate indexes between bed positions, the indexing ports provided in the rotor plate temporarily rotate out of alignment with the corresponding indexing ports provided in the track plate. Material flow path restrictions through the rotary valve thus occur during indexing, which, in turn, results in a temporary decrease in the local pressures of the net streams within the rotary valve. While the decrease in the local pressures of the net streams may be relatively modest, in instances wherein the rotary valve is operating under high throughput conditions, the local pressures can potentially fall below the vaporization or bubble point of the streams' liquid phases and cavitation may result. Cavitation can potentially damage internal components of the rotary valve. In particular, cavitation may tear away or break-up exposed areas of the seal sheet disposed between the rotor and track plates.

It would thus be desirable to provide embodiments of a liquid-solid countercurrent extraction system wherein cavitation within a rotary valve is reliably avoided during indexing of the rotary valve under high throughput conditions. Similarly, it would also be desirable to provide embodiments of a method for reducing the likelihood of rotary valve cavitation during a liquid-solid countercurrent extraction process. Other desirable features and characteristics of embodiments of the present invention will become apparent from the subsequent Detailed Description and the appended Claims, taken in conjunction with the accompanying Drawings and the foregoing Description of Related Art.

### SUMMARY OF THE INVENTION

Embodiments of a liquid-solid countercurrent extraction system are provided. In one embodiment, the extraction system includes an adsorbent chamber and a rotary valve fluidly coupled to the adsorbent chamber. The rotary valve directs a first net stream into a different section the adsorbent chamber in each of a plurality of indexed positions. A first flow control element is fluidly coupled between the rotary valve and the source of the first net stream, and a controller is operably coupled to the first flow control element. The controller is configured to modulate the first flow control element during indexing of the rotary valve to reduce the flow rate of the first net stream and thereby maintain sufficient pressure of the first net stream to prevent cavitation within the rotary valve.

Embodiments of a method for reducing the likelihood of cavitation within a rotary valve during liquid-solid countercurrent extraction are further embodiment. The method is carried-out by a controller included within a liquid-solid countercurrent extraction system of the type that includes at least one flow control element upstream of the rotary valve for modulating the flow rate of at least one net stream supplied to the rotary valve. The rotary valve is movable amongst a plurality of indexed positions. In one embodiment, the method includes the step of commanding the at least one flow control element to reduce the flow rate of the at least one net stream during indexing of the rotary valve.

### BRIEF DESCRIPTION OF THE DRAWINGS

The present invention will hereinafter be described in conjunction with the following drawing figures, wherein like numerals denote like elements, and wherein:

FIG. 1 is a simplified flow schematic of a liquid-solid countercurrent extraction system illustrated in accordance with an exemplary embodiment of the present invention;

FIG. 2 is a cross-sectional view of an exemplary rotary valve suitable for usage within the liquid-solid countercurrent extraction system shown in FIG. 1;

FIGS. 3 and 4 are plan views of an exemplary track plate and an exemplary rotor plate, respectively, that may be included within the rotary valve shown in FIG. 2;

FIG. 5 is a top-down view of the drive assembly included within the exemplary extraction system shown in FIG. 1 and suitable for sequentially moving the rotor plate shown in FIGS. 2 and 4 between indexed positions; and

FIGS. 6-8 are simplified diagrams illustrating, in series, movement of the rotor plate indexing ports relative to the track plate indexing ports during indexing of the exemplary rotary valve shown in FIG. 2.

### DETAILED DESCRIPTION

The following Detailed Description is merely exemplary in nature and is not intended to limit the invention or the application and uses of the invention. Furthermore, there is no intention to be bound by any theory presented in the preceding Description of Related Art or the following Detailed Description.

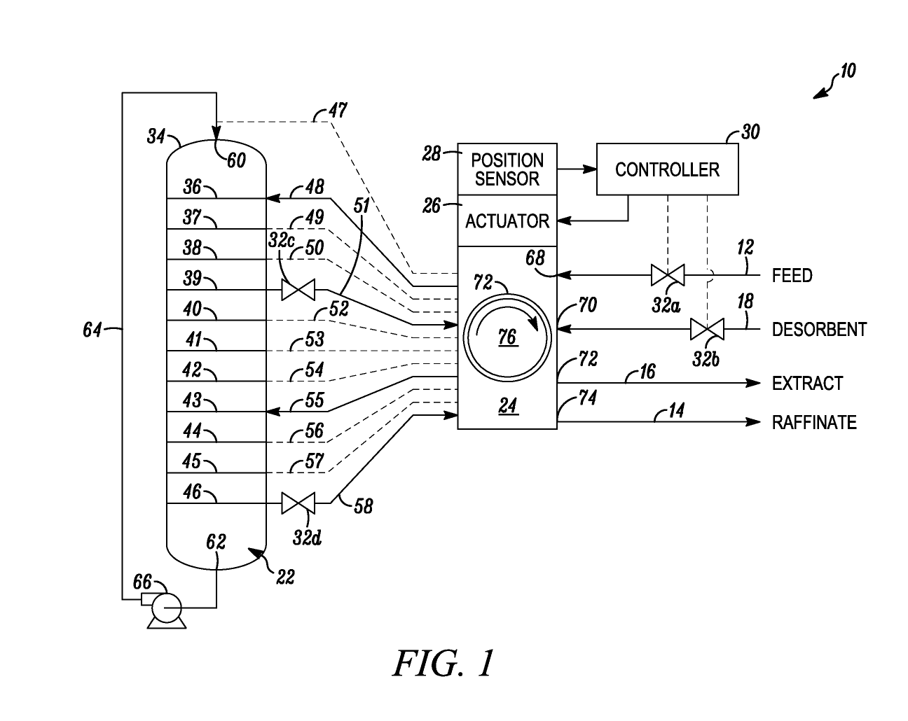

FIG. 1 is a simplified flow schematic of a liquid-solid countercurrent extraction system 10 illustrated in accordance with an exemplary embodiment of the present invention. Liquid-solid countercurrent extraction system 10 is useful for separating a mixed component feed stream 12 into a raffinate stream 14 and an extract stream 16 utilizing a desorbent stream 18 and a solid adsorbent, as described more fully below. Extract stream 16 contains one or more desired products mixed with the desorbent, which may be removed utilizing additional downstream processing equipment, such as an extract column (not shown in FIG. 1 for clarity), to yield a final extract stream having a high purity (e.g., a purity approaching or exceeding 99.9%, by weight). Although by no means limited to the extraction of a particular type of product or products, extraction system 10 may be utilized in the separation ofpara-xylene, meta-xylene, and ehty/-benzene from mixed C8 aromatic isomers; in the separation of linear paraffins from branched and cyclic hydrocarbons; in the separation of olefins from paraffins; in the separation of para-cresol and meta-cresol from other cresol isomers; in the separation ofpara-cymene and meta-cymene from other cymene isomers; and in the separation of fructose from mixed sugars. The assignee of the present application, UOP LLC, headquartered in Des Plaines, Ill., has developed specific processes for recovering each of the products from the mixed component feeds listed above. A family of liquid-solid countercurrent extraction systems and processes is commercially marketed by UOP LLC, under the federally registered trademark SORBEX®.

In the simplified example shown in FIG. 1, liquid-solid countercurrent extraction system 10 includes at least one adsorbent chamber 22, a rotary valve 24, a rotary valve actuator 26, a rotary valve position sensor 28, a system controller 30, and a plurality of flow control elements 32. Adsorbent chamber 22 contains a number of fixed adsorbent beds, which are held within a vessel 34 defining chamber 22. In the illustrated example, adsorbent chamber 22 contains eleven fixed adsorbent beds 36-46, which are spaced along the longitudinal axis of adsorbent chamber 22 at substantially regular intervals. This example notwithstanding, the number and spacing of the fixed adsorbent beds contained within adsorbent chamber 22 will vary amongst different embodiments of liquid-solid countercurrent extraction system 10. Furthermore, while illustrated as including a single adsorbent chamber 22 in FIG. 1, extraction system 10 may include two or more adsorbent chambers in alternative embodiments; e.g., in one implementation, extraction system 10 may include a total of twenty four fixed adsorbent beds divided between two adsorbent chambers. Liquid-solid countercurrent extraction system 10 may also include additional processing equipment (e.g., a raffinate column and an extract column for the desorbent separation and recycling), which is conventionally known within the industry and not described herein.

Adsorbent chamber 22 (or, more accurately, vessel 34) has multiple inlets and outlets for receiving and discharging, respectively, feed stream 12, raffinate stream 14, extract stream 16, and desorbent stream 18. A network of conduits fluidly couples the inlets and outlets of rotary valve 24 to outlets and inlets of adsorbent chamber 22, respectively. The ports of adsorbent chamber 22, the ports of rotary valve 24, and the conduits fluidly connecting these ports are schematically represented in FIG. 1 by flow lines 47-58. As indicated in FIG. 1 by flow lines 48-58, specifically, vessel 34 includes a plurality of sidewall ports corresponding to or indexed to adsorbent beds 36-46 within adsorbent chamber 22. Vessel 34 also includes an upper inlet 60 and a lower outlet 62, which are fluidly coupled by a flow line 64 to complete a pump-around circuit. A pump-around pump 66 is positioned within the pump-around circuit and, when energized, returns the liquid phases received through lower outlet 62 to upper inlet 60 of adsorbent chamber 22. The speed of pump-around pump 66 can be varied, as appropriate, to control the liquid circulation rate through adsorbent chamber 22 during the liquid-solid countercurrent extraction process.

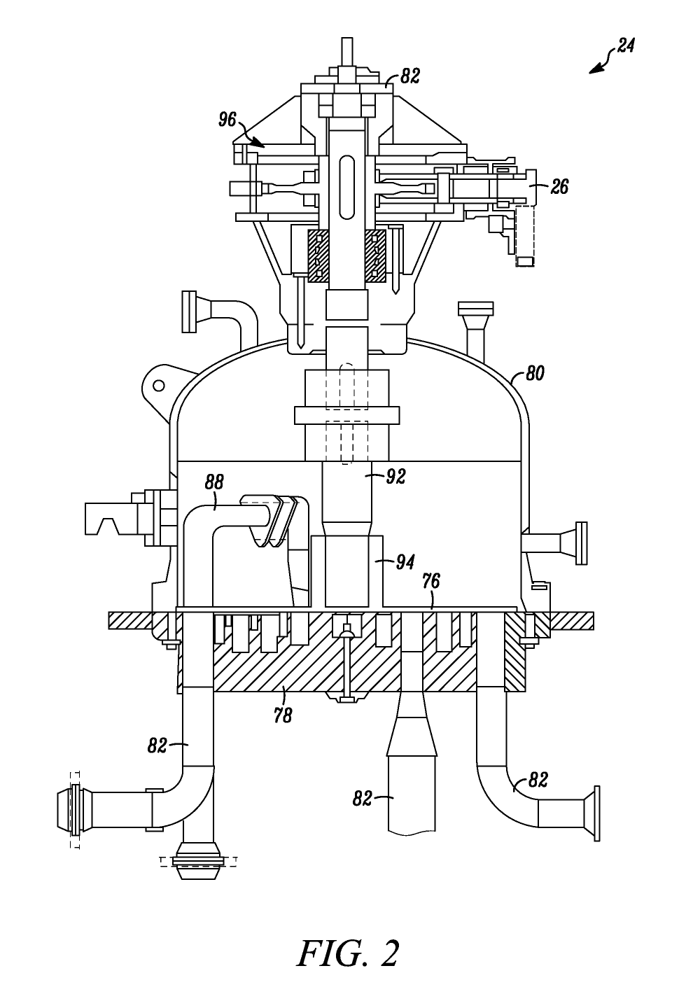

In addition to the ports corresponding to flow lines 47-58, rotary valve 24 further includes: (i) a dedicated feed inlet 68 for receiving feed stream 12, (ii) a dedicated desorbent inlet 70 for receiving desorbent stream 18, (iii) a dedicated extract outlet 72 for the discharge of extract stream 16, and (iv) a dedicated raffinate outlet 74 for the discharge of raffinate stream 14. Rotary valve 24, and specifically a rotor plate 76 included within rotary valve 24 (described below in conjunction with FIGS. 2, 4, and 6-8), is movable amongst a plurality of indexed bed positions. Rotary valve 24 is configured to fluidly couple feed inlet 68, desorbent inlet 70, extract outlet 72, and raffinate outlet 74 to different combinations of flow lines 47-58 depending upon the indexed position of rotor plate 76. To help illustrate this concept, FIG. 1 depicts extraction system 10 at a given juncture during the extraction process wherein flow lines 48, 51, 55, and 58 are fluidly coupled to feed inlet 68, extract outlet 72, desorbent inlet 70, and raffinate outlet port 74, respectively, as indicated in FIG. 1 by solid lines; while flow lines 47, 49, 50, 52-54, and 57 are temporarily inactive, as indicated in FIG. 2 by dashed lines. Rotary valve 24 thus provides a different stream routing to and from adsorbent chamber 22 and fixed adsorbent beds 36-46 in each of the indexed positions.

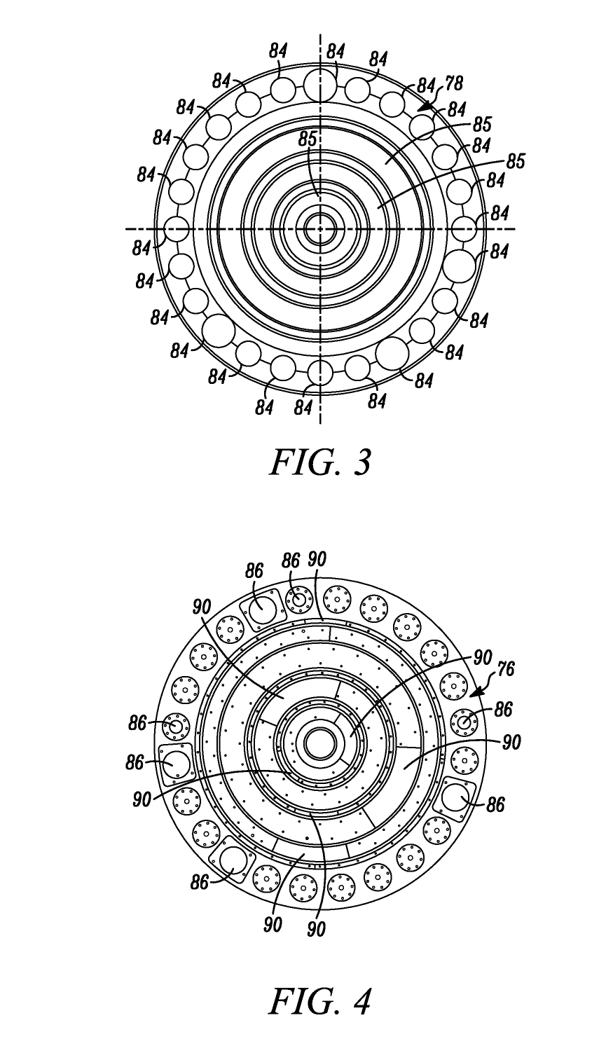

FIG. 2 is a cross-sectional view illustrating rotary valve 24 in accordance with an exemplary embodiment. In addition to rotor plate 76, rotary valve 24 includes a track plate 78 and a bell-shaped casing 80, which is positioned over and supported by track plate 78. Rotor plate 76 is positioned adjacent (e.g., immediately above) track plate 78 and is enclosed by casing 80. Track plate 78 includes a number of external ports, which are coupled the various flow lines and net stream sources described above, as generally indicated in FIG. 2 by conduits 82. A number of indexing ports are further provided through the upper surface of track plate 78 adjacent rotor plate 76. This may be more fully appreciated by referring to FIG. 3, which is a top-down view of track plate 78 illustrating a plurality of indexing ports 84 formed therein. As can be seen in FIG. 3, track plate indexing ports 84 are angularly spaced around an outer annular portion of the upper face of track plate 78. Indexing ports 84 may each be indexed to a different fixed adsorbent bed 36-46 within adsorbent chamber 22. Additional flow passages (e.g., a plurality of concentric annular openings or grooves) may also be provided in the upper face of track plate 78, as generally shown in FIG. 3 at 85.

FIG. 4 is an isometric view of rotor plate 76 illustrated in accordance with an exemplary embodiment. Rotor plate 76 includes a plurality of indexing ports 86, which are provided through the lower face of rotor plate 76. Rotor plate indexing ports 86 are formed in an outer annular portion of the lower face of rotor plate 76 and positioned to align with different combinations of track plate indexing ports 84 (FIG. 3), as determined by the rotational position of rotor plate 76. As further shown in FIGS. 3 and 4 at 90, additional flow passages (e.g., arcuate openings, grooves, slots, or the like) may also be formed in the lower face of rotor plate and positioned so as to align with flow passages 85 of track plate 78 (FIG. 3) and thereby provide further fluid communication between plates 76 and 78 when rotary valve 24 is assembled. Rotor plate 76 may also include a plurality of cross-over lines 88 (one of which is shown in FIG. 2), which fluidly interconnect rotor plate indexing ports 86 and flow passages 90. By way of non-limiting example, further description of rotary valves suitable for usage as rotary valve 24 is provided in U.S. Pat. No. 3,040,777 and U.S. Pat. No. 4,633,904.

With continued reference to FIG. 2, rotary valve 24 is further equipped with a drive assembly 96 including valve actuator 26 and a vertical drive shaft 92. The lower end of drive shaft 92 is fixedly coupled to the rotor plate 76; e.g., as shown in FIG. 2, the lower end of drive shaft 92 may be received within an annular collar 94 extending upwardly from the main body of rotor plate 76. Valve actuator 26 engages the upper end portion of drive shaft 92 and, when actuated, rotates drive shaft 92 to move rotor plate 76 between indexed bed positions in response to command signals received by controller 30 (FIG. 1). Drive assembly 96 further includes an external dial 98 coupled to the upper end of drive shaft 92 to provide a visual indication of the current angular position of drive shaft 92 and, therefore, the current rotational position of rotor plate 76.

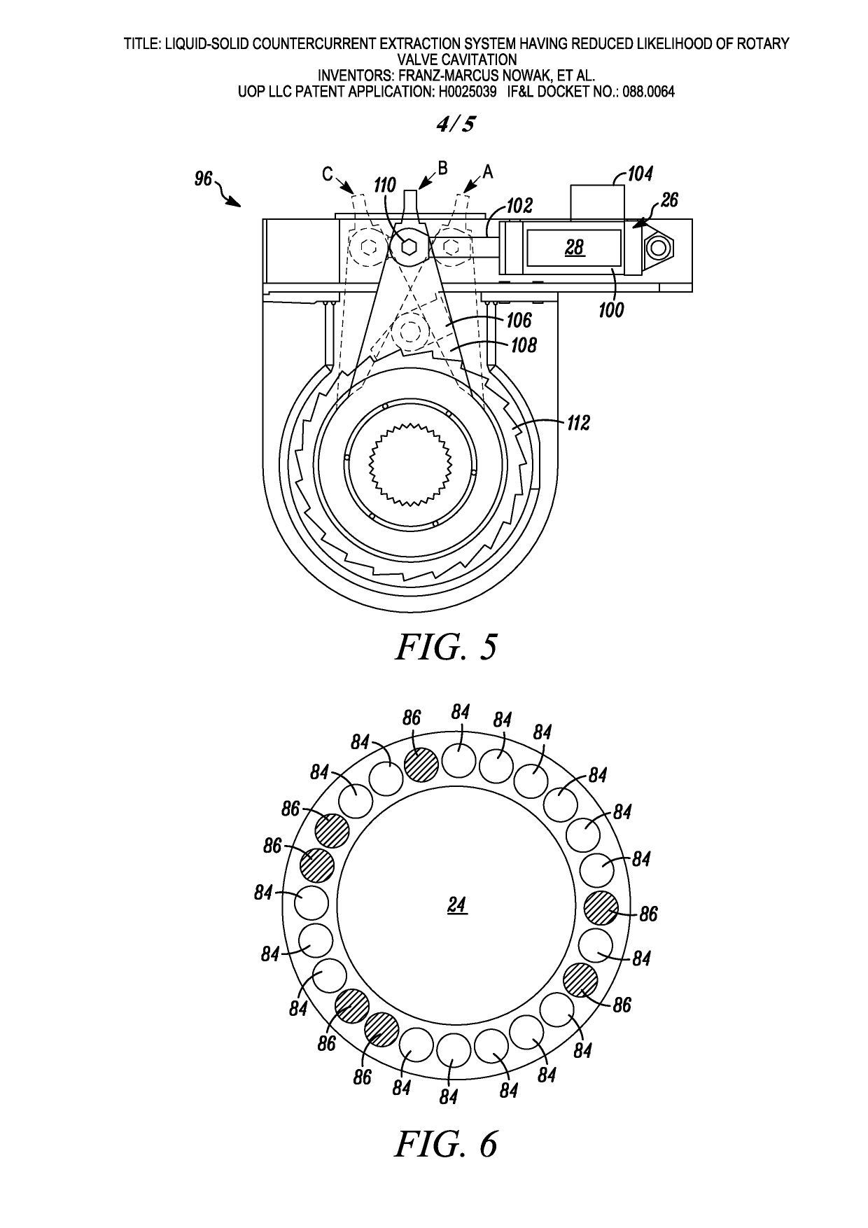

FIG. 5 is a top-down plan view illustrating exemplary drive assembly 96 in greater detail. In this particular example, drive assembly 96 includes a cylinder 100, a piston 102, and a servomotor 104, which collectively serve as valve actuator 16. Drive assembly 96 also includes a pawl 106 and a ratchet arm 108. An end of ratchet arm 108 is pivotally joined to the terminal end of piston 102 utilizing, for example, a bolt 110. The opposing end of ratchet arm 108 engages a spur gear 112, which is fixedly coupled to drive shaft 92 (hidden from view in FIG. 5). As illustrated in FIG. 5 in phantom, piston 102 is movable between at least three positions: a fully retracted position, an intermediate position, and a fully extended position (identified in FIG. 5 as positions “A,” “B,” and “C,” respectively). As piston 102 extends from position A, through position B, and to position C, ratchet arm 108 engages the teeth of gear 112 to rotate gear 112, and therefore drive shaft 92 (FIG. 2), by a predetermined angular displacement. This, in turn, results in the stepped rotation of drive shaft 92 and, therefore, of rotor plate 76. The dimensions of gear 112 and ratchet arm 108, the number of gear teeth, and the translational range of piston 102 are preferably chosen such that each stepped rotation results in movement of rotor plate 76 from one indexed position to the next. In this manner, piston 102 need only be extended and retracted one time to sequentially advance rotor plate 76 to the next indexed bed position. As piston 102 retracts, pawl 106 engages spur gear 112 to rotor plate 76 in its newly-established indexed position until piston 102 is again actuated by controller 30 (FIG. 1). Servomotor 104 can assume any form suitable for actuating piston 102 in this manner, such a hydraulic actuator. In a preferred embodiment, servomotor 104 is an electric servomotor.

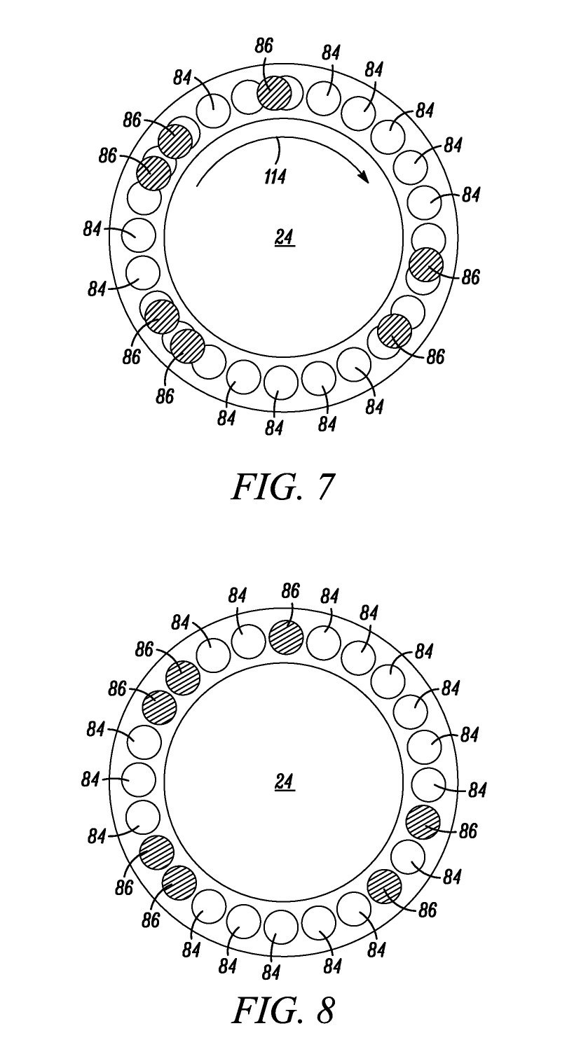

FIGS. 6-8 are diagrams illustrating the movement of rotor plate indexing ports 86 relative to track plate indexing ports 84 during movement of rotary valve 24 (FIGS. 1 and 2) between indexed positions. With respect to FIG. 6, specifically, a first indexed bed position is shown wherein rotor plate indexing ports 86 align with a first combination of track plate indexing ports 74. By comparison, FIG. 8 illustrates a second indexed position wherein rotor plate indexing ports 86 align with a second combination of track plate indexing ports 74. FIG. 7 illustrates an intermediate or mid-step position through which rotor plate 76 rotates when transitioning from the indexed position shown in FIG. 6 to the indexed position shown in FIG. 8, as indicated in FIG. 7 by arrow 114.

As the rotor plate is indexed between bed positions, rotor plate indexing ports 86 temporarily rotate out of alignment with track plate indexing ports 84. A material blockage or reduction in cross-sectional flow area across the rotor plate/track plate interface thus occurs each time the rotor plate, or more generally rotary valve 24, is moved between indexed positions. As may be appreciated by referring to FIGS. 6-8, this reduction in cross-sectional flow area gradually increases as the rotor plate initially rotates from its current indexed position (e.g., the indexed position shown in FIG. 6), peaks in the intermediate or mid-step position (e.g., the intermediate position shown in FIG. 7), and then gradually decreases until the rotor plate rotates fully into its new indexed position (e.g., the indexed position shown in FIG. 8). When the rotary valve is operating under higher throughput conditions, these material flow path restrictions may cause the local pressures of the net streams to fall below the vaporization or bubble point of the streams' liquid phases. Cavitation can thus occur and potentially damage the internal components of rotary valve 24.

To prevent cavitation within rotary valve 24, controller 30 commands flow control elements 32 to temporarily limit the net stream flow rates during rotary valve indexing. By reducing the net stream flow rates, sufficient local pressure of the net streams can be maintained within rotary valve 24 to prevent cavitation. More specifically, controller 30 may modulate flow control elements 32 to reduce the flow rate of the net streams supplied to rotary valve 24 and thereby maintain the local pressures of the net streams above a minimum pressure threshold, which exceeds the vaporization or bubble point of the streams' liquid phases. As appearing herein, the phrase “during indexing of the rotary valve” and similar phrases include the time period during which the rotor plate is moved between indexed bed positions, as well as the time period immediately before (e.g., a few seconds before) indexing movement of the rotor plate. It will be noted that modulation of a given flow control element 32 may assume the form of a flow control valve. Pressure recovery at the outlet of the control valve, expressed as a dimensionless ratio of Cf, or Critical Flow Factor, varies greatly with control valve geometric configuration. Pressure loss attributable to piping friction varies with the square of fluid velocity (Darcy's equation), and a modest reduction in net stream flow rate will result in a relatively large reduction in pressure loss due to piping friction as the stream flows to rotary valve 24. The net stream thus arrives at the rotary valve above its bubble point. Thus, by temporarily decreasing the flow rate through a given conduit or piping leading to the rotary valve via modulation of a given flow control element 32, the pressure of the net stream available at rotary valve 24 may ultimately be increased to prevent cavitation during indexing of the rotary valve. The manner in which controller 30 may command flow control elements 32 to temporarily limit the net stream flow rates during rotor plate indexing and thereby preempt cavitation within the rotary valve is described more fully below.

As shown in the simplified flow schematic shown in FIG. 1, flow control elements 32 include a first flow control element 32(a), which is positioned upstream of feed inlet 68 to selectively control the flow rate of feed stream 12, and a second flow control element 32(b), which is positioned upstream of desorbent inlet 70 to selectively control the flow rate of desorbent stream 18. Additional flow control elements are also preferably positioned upstream of the ports of rotary valve 24, which periodically receive extract and raffinate streams from adsorbent chamber 22 (only two such flow control elements 32(c) and 32(d) are shown in FIG. 1 for clarity). Each stream may have a different minimum pressure threshold depending upon stream composition, temperature, and other operational parameters. Thus, controller 30 may command flow control element 32(a), which is utilized to reduce the flow rate of feed stream 12 in the illustrated example, to reduce the flow rate of feed stream 12 during indexing of rotary valve 24 more or less drastically, as compared to flow control element 32(b), which is utilized to reduce the flow rate of desorbent stream 18. Flow control elements 32 are thus each fluidly coupled between a different inlet of rotary valve 24 and a source of one of the net streams, which may be adsorbent chamber 22 in the case of extract stream 16 and raffinate stream 14 or may be source external to extraction system 10 in the case of feed stream 12 and desorbent stream 18.

Flow control elements 32 may each assume the form of any device suitable for temporarily reducing the rate flow of a net stream in response to command signals received from controller 30. For example, each flow control element 32 may assume the form of a pump having a variable-speed motor, in which case controller 30 may reduce the flow rate through the pump by reducing the pump motor speed. The foregoing notwithstanding, flow control elements 32 each preferably assume the form of a flow control valve capable of providing a relatively rapid reduction in net stream flow rate in response to command signals received from controller 30. In this case, each the flow control valve may normally reside in a fully open position, and controller 30 may command the flow control valves to move into a partially closed position during indexing of rotary valve 24. Flow control elements 32 are sufficiently spaced or offset from rotary valve 24, as taken along their respective flow lines, to allow recovery of any local pressure loss due to the reduction in net stream flow rate prior to reaching rotary valve 24, as previously described.

Controller 30 can assume any form, and may include any number of components, suitable for providing the control functions described herein. In particular, controller 30 may include or cooperate with any number of individual microprocessors, memories, power supplies, storage devices, interface cards, software programs and instructions, and other conventionally-known components suitable for modulating flow control elements 32 to limit the net stream flow rates to rotary valve 24 during indexing thereof In one embodiment, controller 30 assumes the form of an Adsorbent Chamber Control System commonly referred to the acronym “ACCS.” The process described herein is conveniently implemented as an indexing flow control algorithm, which is executed by controller 30 during indexing of rotary valve 24. In embodiments wherein controller 30 normally executes a closed-loop or automatic flow control regime, such as a Proportional Band, Integral, and Derivative (“P-I-D”) flow control regime, controller 30 may temporarily cease execution of the automatic flow control regime and instead perform the indexing flow control algorithm during rotary valve indexing. After indexing of rotary valve 24 is completed, the automatic flow control regime may then be re-established and the flow rates returned to their previous values.

In a preferred embodiment, controller 30 commands flow control elements 32 to reduce the flow rate of each of the net streams based, at least in part, on data received from position sensor 28 indicative of the current rotational position of rotor plate 76. In particular, controller 30 may calculate the reduction in cross-sectional flow area across the interface of the rotor plate and track plate based on data received from position sensor 28 utilizing one or more P-I-D algorithms. Controller 30 may then command flow control elements 32 to each reduce the flow rate of its respective net stream in substantial proportion to the calculated flow restrictions. In this regard, position sensor 28 can assume any form suitable for monitoring the rotational position of rotor plate 76, either directly or indirectly. In one embodiment, position sensor 28 assumes the form of a rotary encoder that monitors the rotational position of rotor plate 76 or the rotational position of drive shaft 92 (FIG. 2). In embodiments wherein valve actuator 16 assumes the form of a linear actuator (e.g., cylinder 100 shown in FIG. 5), position sensor 28 preferably assumes the form of a linear variable differential transformer. For example, as generally illustrated in FIG. 3, position sensor 28 may be mounted to cylinder 100 and provide data to controller 30 (FIG. 1) indicative of the transitional position of piston 102. Position sensor 28 may continually provide such data to controller 30 at a predetermined sampling rate of, for example 0.1 second.

In embodiments wherein position sensor 28 assumes the form of a linear variable differential transformer monitoring the translational position of piston 102 (FIG. 5), controller 30 may determine the degree to which the net stream flow rates should be reduced based upon the translational position or movement of piston 102. In particular, controller 30 may command flow control elements 32 such that the net stream flow rates are gradually reduced during initial extension of piston 102, the reduction in the net stream flow rates peaks near the mid-stroke of piston 102, and the reduction in the net stream flow rates gradually lessens until piston 102 reaches its fully extended position. In this manner, the reduction in net stream flow rate will generally corresponding with the reduction in the cross-sectional flow area across the rotor plate/track plate interface, as described above in conjunction with FIGS. 6-8. It is noted, however, that some lag may occur between translational movement of piston 102 and rotational movement of rotor plate 76 due to torsional deflection of drive shaft 92 (commonly referred to as “shaft wind-up”). If this is the case, controller 30 is preferably configured to compensate shaft wind-up by introducing an appropriate timing delay between detection of the translational movement of piston 102 and command of flow control elements 32 to reduce the net stream flow rates to rotary valve 24.

The foregoing has thus provided embodiments of a liquid-solid countercurrent extraction system wherein cavitation within a rotary valve is reliably avoided during indexing of the rotary valve, even when operating under high throughput conditions. In certain embodiments, the above-described liquid-solid countercurrent extraction system employed at least one valve sensor to monitor rotor plate position during indexing of the rotary valve, and a controller configured to estimate the flow path restrictions, and therefore the local pressure conditions, within the rotary valve. In such embodiments, the controller may execute a suitable control algorithm to preempt cavitation within the rotary valve by temporarily limiting the net stream flow rates during rotor plate indexing.

The foregoing has also provided embodiments of a method for reducing the likelihood of rotary valve cavitation during a liquid-solid countercurrent extraction process. Embodiments of the method may be carried-out by a controller included within a liquid-solid countercurrent extraction system of the type that includes at least one flow control element upstream of the rotary valve for modulating the flow rate of at least one net stream supplied to the rotary valve, which is movable amongst a plurality of indexed positions. In one embodiment, the method includes the step of commanding the at least one flow control element to reduce the flow rate of the at least one net stream during indexing of the rotary valve.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended Claims and their legal equivalents.

What is claimed is:

1. A liquid-solid countercurrent extraction system, comprising:
an adsorbent chamber having a plurality of inlets configured to receive at least a first net stream;
a rotary valve fluidly coupled to the adsorbent chamber and movable amongst a plurality of indexed positions, the rotary valve directing the first net stream into a different inlet the adsorbent chamber in each of the indexed positions;
a first flow control element fluidly coupled between a first inlet of the rotary valve and the source of the first net stream; and
a controller operably coupled to the first flow control element and, during indexing of the rotary valve, modulating the first flow control element to reduce the flow rate of the first net stream and thereby maintain sufficient local pressure of the first net stream to prevent cavitation within the rotary valve.

2. A liquid-solid countercurrent extraction system according to claim 1 wherein the first flow control element comprises a flow control valve.

3. A liquid-solid countercurrent extraction system according to claim 2 wherein the flow control valve normally resides in an open position, and wherein the controller commands the flow control valve to move into a partially closed position during indexing of the rotary valve.

4. A liquid-solid countercurrent extraction system according to claim 1 wherein the first net stream comprises a mixed component feed stream.

5. A liquid-solid countercurrent extraction system according to claim 4 wherein the adsorbent chamber is further configured to receive an adsorbent stream, and wherein the liquid-solid countercurrent extraction system further comprises a second flow control element fluidly coupled between a second inlet of the rotary valve and the source of the adsorbent stream.

6. A liquid-solid countercurrent extraction system according to claim 5 wherein the controller is operably coupled to the second flow control element and is further configured to modulate the second flow control element to reduce the flow rate of the desorbent stream during indexing of the rotary valve.

7. A liquid-solid countercurrent extraction system according to claim 1 wherein the rotary valve comprises:
a track plate having a plurality of track plate indexing ports therein; and
a rotor plate having a plurality of rotor plate indexing ports therein and rotatable relative to the track plate amongst the plurality of indexed positions, the plurality of track plate indexing ports aligning with different combinations of the plurality of rotor plate indexing ports in each of the indexed positions to determine the routing of the first net stream through the rotary valve.

8. A liquid-solid countercurrent extraction system according to claim 7 further comprising a position sensor coupled to the rotary valve and to the controller, the position sensor configured to provide data to the controller indicative of the rotational position of the rotor plate.

9. A liquid-solid countercurrent extraction system according to claim 8 wherein the controller is configured to reduce the flow rate of the first net stream based, at least in part, upon data received from the position sensor during indexing of the rotary valve.

10. A liquid-solvent countercurrent extraction system according to claim 9 wherein the controller is configured to:
calculate the reduction in cross-sectional flow area across the interface of the rotor plate and the track plate based, at least in part, upon data received from the position sensor during indexing of the rotary valve; and
reduce the flow rate of the first net stream in substantial proportion to the calculated reduction in cross-sectional flow area.

11. A liquid-solvent countercurrent extraction system according to claim 8 further comprising a rotary valve actuator coupled to the rotor plate and to the controller, the rotary valve actuator configured to move the rotor plate between indexed positions in response to command signals received from the controller.

12. A liquid-solvent countercurrent extraction system according to claim 11 wherein the position sensor monitors movement of the rotary valve actuator.

13. A liquid-solvent countercurrent extraction system according to claim 12 wherein the rotary valve actuator comprises:
a cylinder; and
a piston translatably mounted to the cylinder;
wherein the position sensor comprises a linear variable differential transducer monitoring the translational movement of the piston.

14. A liquid-solvent countercurrent extraction system according to claim 11 further comprises a drive shaft coupling the rotary valve actuator to the rotor plate, the controller configured to compensate for delay in rotor plate movement relative to movement of the rotary valve actuator due to torsional deflection of the rotor shaft in commanding the first flow control element to reduce the flow rate of the first net stream.

15. A liquid-solid countercurrent extraction system according to claim 1 wherein the controller comprises an adsorbent chamber control system.

16. A liquid-solid countercurrent extraction system, comprising:
a controller;
an adsorbent chamber containing a plurality of fixed adsorbent beds;
a rotary valve fluidly coupled to the adsorbent chamber at a plurality of locations generally corresponding to the plurality of fixed adsorbent beds, the rotary valve comprising:
a track plate; and
a rotor plate adjacent the track plate and rotatable relative thereto amongst a plurality of indexed positions, the rotary valve providing a different stream routing to the adsorbent chamber in each of the indexed positions; and
a rotary valve actuator coupled to track plate and to the controller, the rotary valve actuator configured to move the track plate between the plurality of indexed positions; and
a plurality of flow control valves coupled to the controller, the plurality of flow control valves positioned upstream of the rotary valve and each configured to reduce the flow rate of a different net stream supplied to the rotary valve during indexing in response to command signals received from the controller.

17. A liquid-solid countercurrent extraction system according to claim 16 further comprising a position sensor coupled to the rotary valve and configured to provide the controller with data indicative of the rotational position of the rotor plate.

18. A liquid-solid countercurrent extraction system according to claim 16 wherein the controller is configured to:
calculate the reduction in cross-sectional flow area across the interface of the track plate and rotor plate during rotary valve indexing; and
command the plurality of flow control valves to reduce the net stream flow rates in substantial proportion to the calculated reduction in cross-sectional flow area.

19. A method for reducing the likelihood of cavitation within a rotary valve during liquid-solid countercurrent extraction, the method carried-out by a controller included within a liquid-solid countercurrent extraction system of the type that includes at least one flow control element upstream of the rotary valve for modulating the flow rate of at least one net stream supplied to the rotary valve, the rotary valve movable amongst a plurality of indexed positions, the method comprising:
commanding the at least one flow control element to reduce the flow rate of the at least one net stream during indexing of the rotary valve.

20. A method according to claim 19 wherein the rotary valve comprises a rotor plate rotatably amongst the plurality of indexed positions, wherein the liquid-solid countercurrent extraction system further includes a position operable coupled to the controller and configured to provide data thereto indicative of the rotational position of the rotor plate, and wherein the method further comprises the step of:
modulating the at least one flow control element during indexing of the rotary valve based, at least in part, upon data provided by the position sensor indicative of the rotational position of the rotor plate.
